(19) United States
(12) Patent Application Publication
(10) Pub. No.: US 2010/0263058 A1
(43) Pub. Date: Oct. 14, 2010

(54) Deceptive Mobile Communications

(75) Inventors: Roberto Reta, Richardson, TX (US); Nicholas W. Knize, Rockwall, TX (US); Larry J. Johnson, Sachse, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/421,679

(22) Filed: Apr. 10, 2009

(51) Int. Cl. G06F 21/00; H04Q 5/22

(52) U.S. Cl. 726/28; 340/10.1

(57) ABSTRACT

A system comprises an electronic device operable to perform one or more legitimate functions for an authorized user. The device is further operable to be placed in a deceptive mode and perform one or more deceptive functions for an unauthorized user.

### TECHNICAL FIELD

This disclosure relates in general to communication systems and more particularly to a system for deceptive mobile communications.

### OVERVIEW

Many individuals or organizations may use mobile devices for sensitive and/or confidential tasks. In some instances, unauthorized users may gain control of a mobile device. Sensitive or confidential information may then be subject to theft or other unauthorized uses by the unauthorized users.

### SUMMARY OF EXAMPLE EMBODIMENTS

In accordance with one embodiment of the present disclosure, a system comprises an electronic device operable to perform one or more legitimate functions for an authorized user. The device is further operable to be placed in a deceptive mode and perform one or more deceptive functions for an unauthorized user.

In accordance with another embodiment of the present disclosure, a method comprises providing an electronic device with at least two operating modes comprising a standard mode and a deceptive mode, wherein the electronic device further comprises a trigger. If the trigger is activated, the method further comprises entering the device into the deceptive mode. If the trigger is not activated, the method comprises entering the device into the standard mode.

Numerous technical advantages are provided according to various embodiments of the present disclosure. Particular embodiments of the disclosure may exhibit none, some, or all of the following advantages depending on the implementation. In certain embodiments, lost, stolen, or captured devices may be recovered using information gathered by the device. In addition, in military situations the devices may facilitate the rescue of captured, killed, or wounded soldiers. In some embodiments, devices may be used to secretly gather information about an enemy or unauthorized user and transmit it to the device owner or other authorized individuals or organizations. Devices may also present deceptive information to an enemy or unauthorized user.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a block diagram of an example embodiment of a system comprising one or more devices provide deceptive mobile communications; and

FIG. 2 is a flowchart illustrating one example method of operation of the system depicted in FIG. 1

### DETAILED DESCRIPTION

It should be understood at the outset that, although example implementations of embodiments of the invention are illustrated below, the present invention (as defined by the claims) may be implemented using any number of techniques, whether currently known or not. The present invention (as defined by the claims) should in no way be limited to the example implementations, drawings, and techniques illustrated below. Additionally, the drawings are not necessarily drawn to scale.

Individuals and organizations may use mobile devices for performing tasks, some of which may include sensitive or confidential information. As one example, a business user may use a laptop or mobile phone while traveling to edit, review, or transmit documents containing sensitive proprietary information. As another example, a soldier may use a handheld device while in combat situations to send and/or receive strategic and tactical information or to perform other tasks. In some situations, a device may come under the control of an unauthorized user. For the business user, the device may be left at an airport or hotel and be found by another person. For the soldier, the device may fall into the hands of the enemy if the soldier is wounded, killed, or captured. A device according to some embodiments of the present disclosure may be used that allows for tracking and locating the device, and in some embodiments the device may be used to deceive and/or gather information on the unauthorized user. The device may comprise a standard mode that provides legitimate or standard functions, and a deceptive mode that comprises deceptive functions.

A number of example embodiments in this disclosure will describe a device as used by a soldier in combat situations. However, the embodiments may also be used for civilian applications, such as traveling employees who use devices to work with sensitive company information, or individuals who wish to protect the information on their devices or protect the devices themselves. Some example embodiments may also be used for law enforcement activities.

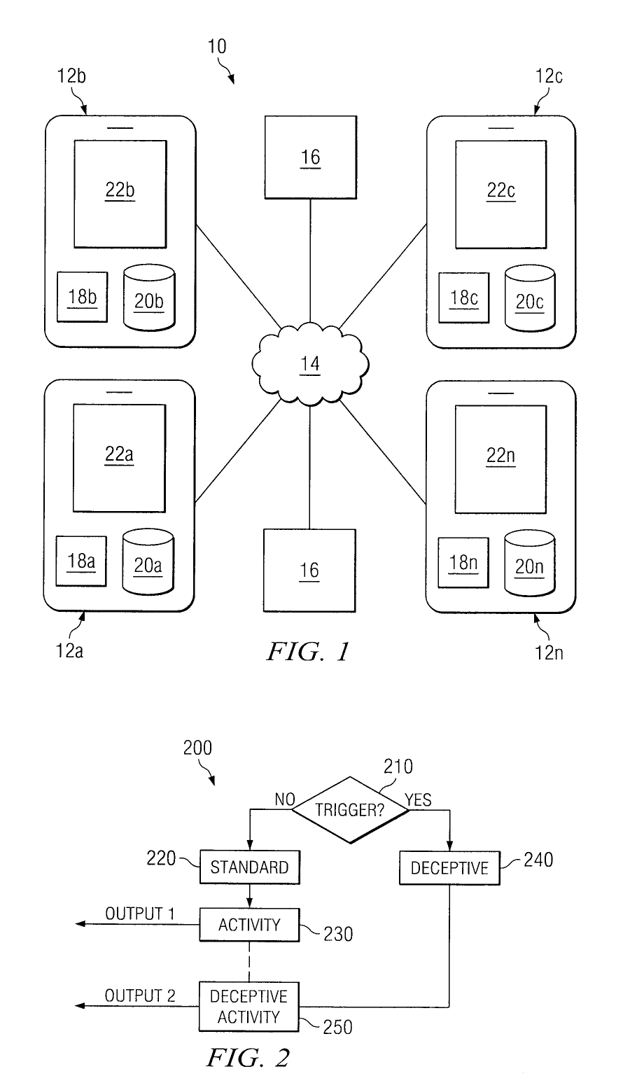

FIG. 1 illustrates a block diagram of an example embodiment of a system 10 comprising one or more devices 12 that may provide deceptive mobile communications. In various embodiments system 10 may comprise a network or communication system used by an entity, such as, for example, a military entity, a business entity, a law enforcement entity, or a consumer entity. It should be appreciated that other embodiments of system 10 may be used without departing from the scope of the present disclosure. In this embodiment, system 10 comprises devices 12a-12n, network 14, and servers 16.

Devices 12a-12n may comprise any device operable to provide one or more functions for one or more users. For example, device 12 may comprise a mobile phone, a portable digital assistant, a computer, or any other type of electronic device. Devices 12 may comprise any type of processor or memory to provide functions for devices 12. As one example, each device 12 may comprise a processor 18 and memory 20 for performing functions and storing data. Devices 12 may further comprise any type of visual display 22, such as an LCD screen. Devices 12 may comprise a microphone and/or speaker for audio interaction in some embodiments. Devices 12 may further comprise GPS capabilities in some embodiments. Devices 12 may also comprise any type of communications capabilities for communicating with one another or with a network, such as Wi-Fi, cellular, or Bluetooth capability. In some embodiments, one or more devices 12 may comprise a computer or other device mounted or housed in a vehicle. Device 12 may comprise video and/or image capture capabilities. Device 12 may also include hardware and/or software to provide one or more sensors to monitor biometric data of a user. Device 12 may further comprise other capabilities other than those described above.

Network 14 may comprise any wireless network, wireline network, or combination of wireless and wireline networks capable of supporting communication between network elements using ground-based and/or space-based components. In some embodiments, network 14 may comprise a cellular network, a Wi-Fi network, a Bluetooth network, a satellite network, or any other type of network. Network 14 may comprise any suitable hardware and/or software for communicating with devices 12 and/or servers 16. Devices 12 may use network 14 to communicate with one another and/or with servers 16. In addition, devices 12 may communicate directly with any other devices 12 and/or directly with one or more servers 16 in some embodiments, without using network 14.

Servers 16 may include any hardware, software, firmware, or combination thereof operable to perform one or more functions in system 10, such as data storage, data retrieval, or processing functions. Server 16 may store information and/or applications using any of a variety of information structures, arrangements, and/or compilations. Servers 16 may, for example, include a dynamic random access memory (DRAM), a static random access memory (SRAM), a NAND flash memory, or any other suitable volatile or nonvolatile storage and retrieval device or combination of devices. Although this example depicts servers 16 as a single medium, servers 16 may comprise any additional number of storage media without departing from the scope of the present disclosure. Although this example depicts two servers 16, any number of servers may be present in system 10.

In some embodiments, devices 12 may be used by soldiers in an army to provide capabilities in combat situations. As one example, each soldier in a unit may be issued a device 12 comprising a handheld communication device. Device 12 may be used by the soldiers to communicate with one another or with other units, commanders, support personnel, etc. Device 12 may also be used to gather and present information to the user. For example, device 12 may have GPS capabilities and the ability to communicate with other devices 12 so that a soldier may see the location of himself and other soldiers on a map, or the location of targets or enemy forces. Device 12 may also have audio and video recording and playback capabilities. Device 12 may also provide access to information stored remotely, such as device stored on servers 16 and accessed through network 14. In some embodiments, device 12 may also interact with other devices, such as data servers or vehicle computers, to provide information to the user. Soldiers using device 12 may be able to add information to device 12 that may be stored locally and retrieved at a later time and/or may be transmitted to other devices 12 or to one or more servers 16. These are merely examples of some of the legitimate functions that may be performed by device 12.

Device 12 may collect information and transmit it to other devices 12 or one or more servers 16 approximately as the information is collected. In some embodiments, device 12 may work outside of a network 14, and may instead store information locally until device 12 comes within range of a suitable network that may be used to transmit data. Device 12 may then upload the information to the network (either automatically or via a user or administrator action) for storage, processing, and/or transmission to other devices 12 or other authorized users.

As described above, device 12 may provide a soldier with an extraordinary amount of useful information in a combat or other military situation. The features and information provided by device 12, however, would also be useful for an enemy who manages to capture one of the devices. For at least this reason, a military that uses device 12 would want to employ strategies to protect the devices, such as requiring a password to log in and/or use device 12, and strategies to assist in the recovery of a lost or captured device. In addition, the features and capabilities of device 12 may be used, in certain embodiments, to collect and/or transmit information about the enemy while the device is under the control of the enemy. Device 12 may also be used to provide incorrect (or deceptive) information to the enemy. This may be accomplished, in certain embodiments, by utilizing a deceptive mode on device 12. In the deceptive mode, device 12 can perform one or more deceptive functions.

Device 12 may comprise, in certain embodiments, two modes of operation. One mode is the normal (or standard) operating mode, which may be used by a soldier to collect information, present information, etc., as described above. A second mode for device 12 is the deceptive operating mode, which may be used when device 12 is lost or captured by an enemy. Device 12 may perform a number of actions while in deceptive mode, which will be described in further detail below. Device 12 may also be placed into the deceptive mode by a number of different actions (or “triggers”), which will also be described in further detail below.

A deceptive mode employed by device 12 may be used for a number of reasons. First, the deceptive mode may be used to ensure that real information does not fall into the hands of the enemy, but that the enemy only receives false or deceptive information. Second, in the deceptive mode device 12 may be performing one or more actions that may facilitate the recovery of device 12. Third, the deceptive mode may be used to gather critical intelligence on the enemy, and in some embodiments the enemy may be unaware that this intelligence is being collected and/or transmitted by device 12. Finally, the deceptive mode may be used to provide the enemy an incentive to continue to use device 12, allowing device 12 to gather more information and to be more easily located.

Various example embodiments of actions that device 12 may perform in deceptive mode will be discussed. These are merely examples and are not intended to limit the scope of the disclosure. In addition, some embodiments of device 12 may perform some, none, or all of these actions.

In deceptive mode, device 12 may transmit its location to assist in its recovery and the rescue of its user. For example, a soldier using device 12 may be captured by enemy forces. During or after the capture, the soldier may be able to place the device in deceptive mode, or an enemy user may inadvertently place the device in deceptive mode. In the deceptive mode, device 12 may use built-in GPS capabilities, for example, and transmit its latitude and longitude location to other devices 12 directly, to other devices 12 through a network such as network 14, or to other users or devices (such as servers 16) on network 14 (such as a central command station). Soldiers using other devices 12 may use this information to locate the captured soldier and his device 12 and attempt a rescue operation. In addition, a commander or other authorized user at a remote location may use the location information of device 12 to attempt a rescue operation or to plan other missions based at least in part on the location information. In some embodiments, device 12 may also transmit a signal specifying that it has been placed in the deceptive mode, which may mean that the user is in trouble. These functions may be performed by device 12 in a hidden or silent manner, without any notification given to an unauthorized user that the device is performing these functions. A number of methods may be used to place device 12 in deceptive mode, and at least some of these methods may allow a rescue or recovery operation to begin almost immediately, which may increase the chances of a successful rescue.

Device 12 may also gather and/or transmit information while in deceptive mode. As an example, a soldier and his device 12 may be captured by enemy forces. Or, alternatively, a device 12 may be lost and recovered by enemy forces. A trigger may be used to place the device in the deceptive mode. Once in the deceptive mode, device 12 may use its capabilities to gather information on the enemy and store and/or transmit that information for use by friendly forces. As one example, when placed in deceptive mode, device 12 may use a video function to begin recording video, unbeknownst to the enemy. The video may be transmitted by device 12 to other devices 12 or to other authorized users in system 10. The video may be used to identify the enemy, identify the location of the captured soldier and/or the enemy forces, and/or gather information about the enemy, such as the size of enemy forces or their plans.

As another example, device 12 may use an audio recording function while in deceptive mode to record sound and transmit that to other devices 12 or other authorized users. Device 12 may be a built-in microphone that may be activated while in deceptive mode and used to record the enemy. The audio recording may be transmitted to friendly forces and analyzed to identify the enemy or to gather intelligence.

In some embodiments, device 12 may be use a camera function to take images while in deceptive mode. Device 12 may take the images and transmit them to other soldiers, who might use them to identify the enemy, find the location of the device and the captured soldier, or gather other intelligence. As with other functions of device 12 in deceptive mode, this function may be performed without notifying the authorized user that the device is collecting and transmitting information.

In some embodiments, device 12 may present deceptive information to the enemy user while in deceptive mode. Device 12 may appear to be operating normally to the enemy user, and in some embodiments may provide the enemy user with a number of capabilities. For example, a soldier may be captured by enemy forces and a trigger may place device 12 in deceptive mode. An enemy user may take device 12 and attempt to use it. The enemy may, as one example, try to make a telephone call with the device. This function may be allowed by device 12 while in deceptive mode. The enemy may also find that the audio and video recording capabilities of device 12 also function. There may be no indication to the enemy that device 12 is in deceptive mode. To the enemy, device 12 appears to be functioning normally. When device 12 switches from regular mode to deceptive mode, there may also be no indication on device 12 that any such switch has occurred. This provides an incentive for the enemy to continue using device 12, and an incentive to keep device 12 and possibly use it for sensitive enemy tasks. While in deceptive mode, however, device 12 may be recording and transmitting information as described above. In some embodiments, device 12 may also present deceptive information to the enemy. That is, in deceptive mode device 12 may allow the enemy user to access files that appear to contain sensitive information, but instead all or some of the information is false and is intended to mislead the enemy user. As one example, device 12 may present false information about the number of troops in the areas near device 12. Device 12 may also present deceptive information about the plans and capabilities of friendly forces.

In some embodiments, device 12 may have deceptive information stored locally on device 12 so that it may be retrieved and used when device 12 enters deceptive mode. In other embodiments, device 12 may retrieve information from another source, such as a server 16 or another device 12, to present to the unauthorized user while in deceptive mode. A combination of locally stored information and remotely stored information may also be used. Device 12 may also be capable of creating deceptive information as needed to present to the enemy user.

In addition to recording audio, video, or images, device 12 may also record keystrokes and store and/or transmit those for analysis. If an enemy user is using device 12 while in deceptive mode, the actions taken by the enemy user may be intercepted by friendly forces. For example, if the enemy user uses the device to make a phone call, the phone number may be recorded and transmitted to friendly forces for analysis. The call itself may also be recorded. Recording and transmitting may occur unbeknownst to the enemy user when device 12 is in the deceptive mode.

Device 12 may also be capable of executing remote commands in some embodiments. As one example, when device 12 is in deceptive mode it may be recording and transmitting video and audio to a remote server 16. A person at a remote command station may be monitoring the transmitted information from device 12. The monitoring individual may have the capability to send instructions to device 12 as to what actions to perform next. Device 12 may be instructed to take specific action, which may be taken in the deceptive mode unbeknownst to an enemy user. In one embodiment, the monitoring individual may instruct device 12 to present deceptive information about troop formations, or any other type of information. In another embodiment, device 12 may be instructed to stop recording audio and begin taking high-resolution images. The monitoring individual may have the ability to instruct device 12 to perform any task of which device 12 is capable. Device 12 in this embodiment may be used as a controllable intelligence-gathering tool and/or a controllable disseminator of deceptive information, and may also perform these actions without any indication to an enemy user of what device 12 is doing.

Device 12 may also be used for a variety of non-military activities. As one example, a business may issue laptops or cellular phones to its employees. These devices may contain sensitive proprietary information. To protect the information and the devices, the devices may employ a deceptive mode that transmits the devices location upon the activation of a trigger. A device may transmit its GPS coordinates if an unauthorized user attempts to log in. These GPS coordinates may be transmitted via Wi-Fi or a cellular network, and may be received by an entity at the business' headquarters and/or the authorized user of the device. The device may then be located using the coordinates. The device may also take images, audio, or video and transmit that for use in recovering the device. As another example, a device in deceptive mode may display fake emails, fake documents, or other fake information so that real proprietary information is not discovered by an authorized user. Some of the functions of the device may also be usable in deceptive mode, so that the unauthorized user continues to use it and the device may continue to gather information about its surroundings and transmit it for recovery.

Embodiments of device 12 and system 10 may be used for consumer products as well. For example, a cellular phone provider may provide a deceptive mode for the cellular phones it sells or services. If a user loses the phone, the phone may enter into a deceptive mode using any of a variety of triggers, and in the deceptive mode the phone may transmit GPS coordinates and/or images, audio, or video to assist in recovering the device. Deceptive modes may also be used for other electronic devices, such as PDAs, computers, etc.

Device 12 may be placed in a deceptive mode by one or more triggers. A trigger may be any action or occurrence that places device 12 in deceptive mode. As one example, device 12 may be placed in deceptive mode with a password. For example, an authorized user of device 12 may enter a particular password to place device 12 in deceptive mode. In other embodiments, a specific pattern of keystrokes or other user gestures may be used to place device 12 in deceptive mode.

As another example, the trigger to place device 12 in deceptive mode may comprise a specific number of incorrect passwords. Device 12 may allow, for example, five attempts at a password needed to unlock the device. After the fifth unsuccessful attempt, device 12 may enter into deceptive mode. An unauthorized user may believe that the correct password was entered and device 12 is operating normally. Instead, device 12 will be taking one or more actions in deceptive mode.

As yet another example, device 12 may be entered into deceptive mode by an incorrect response to a prompt. Device 12 may require a user to answer a question before it allows the user to proceed using the device. Presumably, an authorized user will know the answer to the question, and if the question is answered correctly device 12 will function normally. If answered incorrectly, device 12 may enter deceptive mode.

As yet another example, device 12 may enter deceptive mode based on its distance from another object. A soldier may carry an RFID tag that may be read by device 12. When device 12 detects that the RFID tag is a specific distance away (such as ten feet or more, in one example), device 12 enters into deceptive mode. This may be used as a security feature; if a soldier is separated from his device there is likely a problem, and the device needs to go into deceptive mode to facilitate its recovery or to gather and transmit information. Other technologies may be used, besides RFID, to implement distance as a trigger for deceptive mode, such as GPS. Any distance between device 12 and the tag may be used as the trigger.

The location of device 12 may also be a trigger that puts device 12 in deceptive mode. Device 12 may monitor its GPS coordinates and enter into deceptive mode when it is in certain locations. As an example, certain locations on a battlefield that are known to be under enemy control may be designated as deceptive mode locations for certain devices 12. When device 12 enters those locations, it enters into deceptive mode for defensive purposes and/or for intelligence gathering purposes.

Device 12 may also enter into deceptive mode based on a user's biometric data or a change in the user's biometric data. As one example, device 12 may be operable to monitor the heart rate of its authorized user, either directly or by receiving information from an external monitor. If the user's heart rate increases beyond a predetermined threshold, device 12 may enter deceptive mode. The increased heart rate may be an indication that the user is in trouble. As another example, if the heart rate of the user falls below a certain threshold, this may also be a sign of trouble and may trigger device 12 into deceptive mode. Device 12 may monitor any type of biometric data and employ any number of different rules for entering into deceptive mode or exiting out of deceptive mode. Device 12 may store and/or transmit the biometric data for use by other military personnel as well. Information may be transmitted to other devices 12 or network 14 where it may be accessed by other authorized users.

Device 12 may also enter deceptive mode via voice activation. In some situations, such as combat situations, a soldier may not be able to enter a password into device 12 using a keyboard, for example. In that case, the soldier may speak a password or phrase that places device 12 into deceptive mode. This may also be used if a soldier is captured by the enemy and doesn't have access to device 12, but is within range of a microphone integrated in device 12. The soldier may speak the password and place device 12 into deceptive mode, and in some cases this may be achieved without alerting the enemy that any change has occurred with device 12.

As yet another example of a trigger, device 12 may be placed into deceptive mode via a remote signal. In this embodiment, a commander or remote monitor may be able to observe events happening near device 12. The remote monitor may also be able to receive information from device 12, such as audio, video, location information, images, biometric data of users, etc. The remote monitor may use this all of this data to determine if any particular device 12 should be placed into deceptive mode. At any time the remote monitor may send a signal (either directly or via any suitable network) to one or more devices 12 to place them into deceptive mode. For example, the remote monitor may notice that the user of a particular device 12 has a high heart rate. This may be an indication of trouble, and the remote monitor may place device 12 into deceptive mode to protect the contents of the device and/or gather information on the situation. In some embodiments the remote monitor may take the device into and out of deceptive mode at will. Other embodiments may employ rules that govern how the deceptive mode may be used. Some embodiments may employ methods for the authorized user of device 12 to take it out of deceptive mode if, for example, the situation does not warrant the use of deceptive mode.

As another example embodiment, device 12 may be intentionally planted near an enemy or given directly to an enemy so it may be used as an intelligence-gathering device. In this example, device 12 may be placed into deceptive mode before it is planted near the enemy. Or, in other embodiments device 12 may be placed in deceptive mode after it is triggered by an unauthorized user or some other trigger (for example, it may be placed in deceptive mode by a remote signal). The enemy may find the device and begin using it, and because the device is in deceptive mode the enemy believes that he is receiving strategic military information. Instead, the enemy may be receiving false information, such as the number and location of troops, plans for troop movements, and/or plans for missions. While device 12 is providing this deceptive information, device 12 may also be secretly recording and transmitting information about its surroundings, such as GPS coordinates, images, audio, and/or video. This information may be transmitted to friendly forces to allow them to gather intelligence on the enemy using device 12.

FIG. 2 is a flowchart illustrating one example method 200 of operation of system 10 depicted in FIG. 1. In particular, the illustrated technique may determine whether device 12 will operate in standard mode or deceptive mode. The steps illustrated in FIG. 2 may be combined, modified, or deleted where appropriate. Additional steps may also be added to the example operation. Furthermore, the described steps may be performed in any suitable order.

At step 210, the system determines whether to use the standard mode or operation or the deceptive mode based on the occurrence of a trigger. As described above, any of a number of triggers may be used to put device 12 into deceptive mode. In one embodiment, an authorized user may be prompted as to whether device 12 should be put in deceptive mode. The system may use a combination of information and/or triggers to determine whether to place device 12 in deceptive mode in some embodiments. If the system determines to use standard mode, the process proceeds to step 220. If the system determines to use deceptive mode, the process proceeds to step 240.

At step 220, the system is in standard mode. The system may process inputs normally, and the authorized user may use device 12 for any of its capabilities. Step 230 illustrates the use of device 12 for standard activities. Device may produce one or more outputs. Device 12 may be switched to deceptive mode later if one of the deceptive mode triggers occurs.

If the system determined that deceptive mode should be used in step 210, the process proceeds to step 240, as described above. In step 240, the system is in deceptive mode. In one example embodiment, device 12 turns on one or more information gathering capabilities, such as video, audio, and GPS, and broadcasts that information silently to other devices 12 or to network 14. In addition, device 12 may record and broadcast inputs from unauthorized users. Device 12 may appear to function normally to the unauthorized user, and may also present false or deceptive information to the unauthorized user. These deceptive actions are illustrated in step 250. Device 12 may produce one or more outputs.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
an electronic device operable to perform one or more legitimate functions for an authorized user, and further operable to be placed in a deceptive mode and perform one or more deceptive functions for an unauthorized user.

2. The system of claim 1, wherein the device is placed in the deceptive mode when the authorized user and the device are separated by a predetermined distance.

3. The system of claim 1, wherein the device is placed in deceptive mode by entering a password.

4. The system of claim 1, wherein the device is placed in deceptive mode by inputting a predetermined number of incorrect passwords.

5. The system of claim 1, wherein the device is placed in deceptive mode based on its location.

6. The system of claim 1, wherein the device is placed in deceptive mode when a change is detected in a biometric measurement of the authorized user.

7. The system of claim 1, wherein the device is placed in deceptive mode via voice activation by the authorized user.

8. The system of claim 1, wherein the device is placed in deceptive mode by a remote signal.

9. The system of claim 1, wherein the device is placed in deceptive mode when an incorrect input is given in response to a prompt.

10. The system of claim 1, wherein the device comprises a mobile telephone.

11. The system of claim 1, wherein the device comprises a portable computer.

12. The system of claim 1, wherein the device comprises a personal digital assistant.

13. The system of claim 1, wherein the device is implemented in a vehicle.

14. The system of claim 1, wherein the device records information while in deceptive mode.

15. The system of claim 14, wherein the information comprises video.

16. The system of claim 14, wherein the information comprises audio.

17. The system of claim 14, wherein the information comprises images.

18. The system of claim 1, wherein the device transmits it location while in deceptive mode.

19. The system of claim 1, wherein the device appears to function normally to the unauthorized user while in deceptive mode.

20. The system of claim 1, wherein the device records keystrokes while in deceptive mode.

21. The system of claim 1, wherein the device transmits information while in deceptive mode.

22. The system of claim 1, wherein the device provides false information to the unauthorized user while in deceptive mode.

23. The system of claim 1, wherein the device receives and executes one or more commands from the authorized user or a third party while in deceptive mode, and wherein the execution of the one or more commands is hidden from the unauthorized user.

24. A method, comprising:
providing an electronic device with at least two operating modes comprising a standard mode and a deceptive mode, wherein the electronic device further comprises a trigger;
if the trigger is activated:
entering the device into the deceptive mode; and
if the trigger is not activated:
entering the device into the standard mode.

25. The method of claim 24, further comprising recording information and transmitting information from the device to a network while in the deceptive mode.

26. The method of claim 24, further comprising transmitting a location of the device while in the deceptive mode.

27. The method of claim 24, wherein the trigger comprises a location of the device.

28. The method of claim 24, wherein the trigger comprises a password.

29. The method of claim 24, wherein the trigger comprises the device exceeding a predetermined distance from an authorized user.

30. The method of claim 29, wherein the trigger comprises a change in a biometric measurement of the authorized user.

31. The method of claim 24, further comprising presenting deceptive information from the device to an unauthorized user while in the deceptive mode.

32. A system, comprising:
an electronic device operable to perform one or more legitimate functions for an authorized user, wherein the device and the authorized user are coupled via an RFID tag, and wherein the device is placed in a deceptive mode when the authorized user and the device are separated by a predetermined distance;
wherein the device is further operable, while in the deceptive mode, to present one or more pieces of false information to an unauthorized user; and
wherein the device is further operable to record audio information while in the deceptive mode and transmit the audio information to a network without indicating the recording and transmission to the unauthorized user.
